(19) United States
(12) Patent Application Publication
(10) Pub. No.: US 2007/0111924 A1
(43) Pub. Date: May 17, 2007

(54) Liquid laundry detergent composition with naturally derived alkyl or hydroxyalkyl sulphate or sulphonate surfactant and mid-chain branched amine oxide surfactants

(75) Inventor: Francis Cornelio Ford, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/599,858

(22) Filed: Nov. 15, 2006

Related U.S. Application Data
(60) Provisional application No. 60/736,682, filed on Nov. 15, 2005.

(51) Int. Cl. C11D 3/37

(52) U.S. Cl. 510/499

(57) ABSTRACT

Liquid laundry detergents having a specified surfactant system of naturally derived alkyl or hydroxyalkyl sulphate or sulphonate surfactant and mid-chain branched amine oxide surfactants having a desired viscosity profile.

### CROSS REFERENCE TO RELATED APPLICATION

This application claims priority to U.S. Provisional application No. 60/736,682, filed Nov. 15, 2005.

### FIELD OF THE INVENTION

Liquid laundry detergents having a specified surfactant system of naturally derived alkyl or hydroxyalkyl sulphate or sulphonate surfactant and mid-chain branched amine oxide surfactants.

### BACKGROUND OF THE INVENTION

Liquid cleaning compositions such as hand dishwashing detergents or liquid laundry detergent are desired to have a certain viscosity profile while in the package (package viscosity) and during the dissolution of the liquid cleaning composition, typically in a volume of water or into a container capable of holding water wherein water is then added.

It is undesirable for the viscosity profile of a liquid cleaning composition to be too thick or gel-like in character (high in viscosity) while in its package and when in use. However, it is also undesirable for the viscosity profile of the liquid cleaning composition to be too thin or water-like in character (low in viscosity) while in its package and when in use. For most liquid cleaning compositions, the viscosity profile generally increases from the package viscosity upon dilution in water as surfactants in the liquid cleaning composition are believed to undergo a phase transition which increases viscosity and decreases solubility of the liquid detergent composition.

The use of linear amine oxides and alkoxylated alkyl sulfates are recognized as a desired surfactant system in liquid hand dishwashing detergent. However, with ever increasing prices in petrochemically derived materials, the use of naturally derived materials have become increasingly attractive. However, as naturally derived materials have distinct properties from petrochemically derived materials, these materials cannot be considered fungible. It has been found that the combination of linear amine oxides and naturally derived alkyl or hydroxyalkyl sulphate or sulphonate surfactants result in an undesired viscosity profile for a liquid cleaning combination.

Previously discussed solutions to viscosity issues include the addition of solvents such as ethanol and glycols (See U.S. PAT. No. 4,384,978 A), lower aliphatic sulfonic acids (See U.S. PAT. No. 3,970,596 A), isethionates (See U.S. PAT. No. 3,970,596 A), salts of an alcohol ether sulphate (see EP 0059043 B1), inorganic salts and anti-gelling polymers (see EP 0816479 B1).

However additional materials to obtain only the desired viscosity profile add to the cost of any liquid cleaning composition. Therefore it is desired to have a liquid cleaning composition having an appropriate viscosity profile that is not dependent upon the addition of materials that do not contribute to cleaning benefits.

### SUMMARY OF THE INVENTION

The present invention relates to a liquid detergent composition comprising: (a) naturally derived C₁₀₋₂₀ alkyl or hydroxyalkyl sulphate or sulphonate surfactant; (b) mid-chain branched amine oxide comprising one alkyl moiety having n₁ carbon atoms and an alkyl branch having n₂ carbon atoms, wherein the alkyl branch is located on the α or β carbon from the nitrogen; and (c) a liquid carrier.

The present invention further relates to a method of using the liquid detergent composition.

### DETAILED DESCRIPTION OF THE INVENTION

As used herein “light-duty liquid dishwashing detergent composition” refers to those compositions that are employed in manual (i.e. hand) dishwashing. Such compositions are generally high sudsing or foaming in nature.

As used herein “laundry detergent composition” refers to those compositions that are employed in washing clothing and other fabrics and any solutions containing the composition in a diluted form. Such compositions are generally low sudsing or foaming in nature.

As used herein “naturally derived” means that the surfactants discussed are derived from naturally occurring fatty acids such as canola, castor, coconut, corn, cottonseed, linseed, olive, palm, palm kernel, peanut, rapeseed, safflower, sesame, soybean, sunflower, lard, tallow, and any similar materials that are not derived from petrochemical feedstocks.

As used herein “desired viscosity profile” means the package viscosity and viscosity upon dissolution of a liquid detergent composition at 100 wt %, 80 wt % and 10 wt %, by weight of the liquid detergent composition discussed further below in the Test Method section. The desired viscosity profile is dependent upon whether a “high viscosity formulation” or a “low viscosity formulation” is desired. Generally, the absolute value change between the 100 wt % and the 80 wt % viscosity (discussed below in Test method section) should be minimized and the absolute value change between the 100 wt % and the 10 wt % maximized for high viscosity formulations and controlled for low viscosity formulations. Without being limited by a theory it is believed that such a viscosity profile has an improved dissolution of the liquid detergent composition in water.

As used herein “high viscosity formulation” means a liquid detergent composition wherein the 100 wt % viscosity is less than or equal to 700 cps, preferably from 10 to 680 cps and the absolute value of the change in viscosity from 100 wt % and 80 wt % is from 0 to 100 cps, preferably from 0 to 75 cps, more preferably from 0 to 50 cps; and the absolute value of the change in viscosity from 100 wt % and 10 wt % should be greater than 500 cps, preferably from 550 to 800 cps.

As used herein “low viscosity formulation” means a liquid detergent composition wherein the 100 wt % viscosity is less than or equal to 300 cps, preferably from 10 to 250 cps and the absolute value of the change in viscosity from 100 wt % and 80 wt % is from 0 to 50 cps, preferably from 0 to 40 cps, more preferably from 0 to 30 cps; and the absolute value of the change in viscosity from 100 wt % and 10 wt % should be from 10 to 150 cps, preferably from 20 to 120 cps.

As used herein “package” means any container capable of holding a liquid detergent composition.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the liquid detergent composition. All temperatures, unless otherwise indicated are in Celsius.

It has been found that the combination of mid-branched amine oxide surfactants and naturally derived C₁₀₋₁₄ alkyl or hydroxyalkyl sulphate or sulphonate gives the desired viscosity without the addition of other materials.

Mid-Branched Amine Oxide Surfactants

The liquid detergent compositions herein comprise from about 0.1% to about 15% by weight of the liquid detergent composition of a mid-branched amine oxide surfactant. As used herein “mid-branched” means that the amine oxide has one alkyl moiety having n₁ carbon atoms with one alkyl branch having n₂ carbon atoms. The alkyl branch is located on the α or β carbon from the nitrogen.

When the alkyl branch is located on the α carbon from the nitrogen, the total sum of n₁ and n₂ is from 10 to 24 carbon atoms, preferably from 12 to 20, and more preferably from 10 to 16. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁−n₂| is less than or equal to 5, preferably 4, most preferably from 0 to 4 carbon atoms in at least 35 wt %, preferably from 40%, more preferably at least 50 wt % to 100 wt % of the mid-branched amine oxides for use herein.

When the alkyl branch is located on the β carbon from the nitrogen, the total sum of n₁ and n₂ is from 10 to 24 carbon atoms, preferably from 12 to 20, more preferably from 10 to 14. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁−n₂| is less than or equal to 5 carbon atoms in at least 35 wt %, preferably at least 40%, more preferably at least 50 wt % to 100 wt % of the mid-branched amine oxides for use herein. The one alkyl branch located on the β carbon from the nitrogen preferably has |n₁−n₂| less than 4 carbon atoms.

One of skill in the art will recognize that alkoxylation of the one alkyl moiety may be accomplished by known methods. Preferably alkoxylation results in block alkoxylation between the nitrogen and the one alkyl moiety. In such a case, the “α carbon from the nitrogen” and “β carbon from the nitrogen” described above will be only be referring to the one alkyl moiety carbon atoms and not the carbon atoms in the alkoxy portion of the amine oxide. Preferred are ethoxy, propoxy, and butoxy for alkoxylation.

Without being limited by a theory, it is believed that the symmetric structure of the mid-branched amine oxide improves (disrupts) the surfactant packing and reduces the viscosity to desired levels verses asymmetric branched amine oxides. As used herein “asymmetric” means |n₁−n₂| is greater than 5 carbon atoms.

The amine oxide further comprises two moieties, independently selected from a C₁₋₃ alkyl, a C₁₋₃ hydroxyalkyl group, or a polyethylene oxide group containing an average of from about 1 to about 3 ethylene oxide groups. Preferably the two moieties are selected from a C₁₋₃ alkyl, more preferably both are selected as a C₁ alkyl.

In one embodiment, as shown in formula (I), R₁ as the one alkyl branch is selected to be a similar or same carbon number as R₂, the one alkyl moiety such that the one alkyl moiety and the one alkyl branch are symmetric. 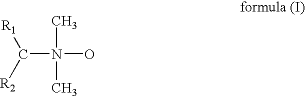
wherein R₁ and R₂ of formula (I), plus the one carbon between the nitrogen and R₁ and R₂, have 10-24 carbon atoms.

Mid-branched amine oxides of formula (I) may be derived from different hydrophobe sources. One hydrophobe source is from alcohols such as that sold under the tradename TERGITOL® from The Dow Chemical Company. The alcohols are processed to produce tertiary amines, which are further oxidized by hydrogen peroxide to produce mid-branched amine oxides such as that shown in formula (I). Processes that may be used are discussed in Lonza (U.S. Pat. No. 6,376,713) and by Kao (U.S. Pat. No. 5,266,730).

A further hydrophobe source is from internal olefins. A hydrohalogenation process, such as hydrobromination, hydrochlorination or hydroiodination; can be used to produce tertiary amines, which are further oxidized to produce mid-branched amine oxides such as those shown in formula (I). See copending U.S. provisional application No. 60/627980 filed Nov. 15, 2004, by Kenneally, et al. Alternatively, internal olefins via an aminomethylation process can be used to produce tertiary amines, which are further oxidized to product mid-branched amine oxides such as those shown in formula (I). See copending U.S. provisional application No. 60/627959 filed Nov. 15, 2004, by Kenneally, et al. In one embodiment, as shown in formula (II), R₁ as the one alkyl branch is selected to be a similar or same carbon number as R₂, the one alkyl moiety such that the one alkyl moiety and the one alkyl branch are symmetric: 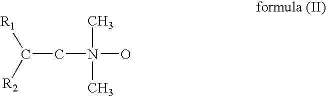
wherein R₁ and R₂ of formula (II), plus the two carbons between the nitrogen and R₁ and R₂, have 10-24 carbon atoms.

Another hydrophobe source is from Guerbet and other Aldol alcohols, such as ISOFOL® or ISALCHEM® alcohols from Sasol. These alcohols are processed to produce the tertiary amines, which are further oxidized by hydrogen peroxide to produce mid-branched amine oxides such as that shown in formula (II).

A further hydrophobe source for formula (II) is from internal olefins. A hydrohalogenation process, such as hydrobromination, hydrochlorination or hydroiodination; can be used to produce tertiary amines, which are further oxidized to produce mid-branched amine oxides such as those shown in formula (I). See co-pending U.S. Ser. No. 60/627980. Alternatively, internal olefins via an aminomethylation process can be used to produce tertiary amines, which are further oxidized to product mid-branched amine oxides such as those shown in formula (I). See U.S. Ser. No. 60/627959.

Anionic Surfactants

Naturally Derived C₁₀₋₂₀ Alkyl Or Hydroxyalkyl Sulphate Or Sulphonate

The naturally derived C₁₀₋₂₀ alkyl or hydroxyalkyl sulphate or sulphonate surfactant is present at a level of at least 10%, more preferably from 20% to 40% and most preferably from 20% to 30% by weight of the liquid detergent composition.

Suitable C₁₀₋₂₀ alkyl or hydroxyalkyl sulphate or sulphonate surfactants for use in the compositions herein include water-soluble salts or acids of naturally derived C₁₀-C₁₄ alkyl or hydroxyalkyl, sulphate or sulphonates. Suitable counterions include hydrogen, alkali metal cation or ammonium or substituted ammonium, but preferably sodium.

The alkyl or hydroxyalkyl sulphate or sulphonate surfactants may be selected from C₁₁-C₁₈ alkyl benzene sulfonates (LAS), C₁₀-C₂₀ primary, branched-chain and random alkyl sulfates (AS); C₁₀-C₁₈ secondary (2,3) alkyl sulfates; C₁₀-C₁₈ alkyl alkoxy sulfates (AEₓS) wherein preferably x is from 1-30; C₁₀-C₁₈ alkyl alkoxy carboxylates preferably comprising 1-5 ethoxy units; paraffin sulfonates, methyl ester sulfonate (MES); and alpha-olefin sulfonate (AOS).

The naturally derived C₁₀₋₁₄ alkyl or hydroxyalkyl sulphate or sulphonate surfactant may also be mixed with mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.

Aqueous Liquid Carrier

The liquid dishwashing detergent compositions herein further contain from about 20% to 80% of an aqueous liquid carrier in which the other essential and optional compositions components are dissolved, dispersed or suspended. More preferably the aqueous liquid carrier will comprise from about 30% to about 70%, more preferable from about 45% to about 65% of the compositions herein.

One preferred component of the aqueous liquid carrier is water. The aqueous liquid carrier, however, may contain other materials which are liquid, or which dissolve in the liquid carrier, at room temperature (20° C.-25° C.) and which may also serve some other function besides that of an inert filler. Such materials can include, for example, hydrotropes and solvents, discussed in more detail below. Dependent on the geography of use of the liquid detergent composition of the present invention, the water in the aqueous liquid carrier can have a hardness level of about 2-30 gpg (“gpg” is a measure of water hardness that is well known to those skilled in the art, and it stands for “grains per gallon”).

Thickness of the Composition

The compositions of the present invention are preferably thickened and have package viscosity of greater than 80 cps, when measured at 20° C. More preferably the package viscosity of the liquid detergent composition is less than or equal to 200 cps for Asian regions such as Japan and less than or equal to 700 cps for regions such as North America and Western Europe. The present invention excludes compositions which are in the form of microemulsions.

pH of the Composition

The liquid detergent composition may have any suitable pH. Preferably the pH of the composition is adjusted to between 4 and 14. More preferably the composition has pH of between 6 and 13, most preferably between 6 and 10. The pH of the composition can be adjusted using pH modifying ingredients known in the art.

Surfactants

The liquid detergent composition of the present invention may further comprise surfactants other than the mid-branched amine oxide, C₁₀₋₁₄ alkyl or hydroxyalkyl sulphate or sulphonate, dialkylsulfosuccinate, and linear amine oxides surfactants discussed above, and are selected from nonionic, anionic, cationic surfactants, ampholytic, zwitterionic, semi-polar nonionic surfactants, and mixtures thereof. Optional surfactants, when present, may comprises from about 0.01% to about 50% by weight of the liquid detergent compositions of the present invention, preferably from about 1% to about 50% by weight of the liquid detergent composition. Non-limiting examples of optional surfactants are discussed below.

Dialkylsulfosuccinates

An optional component used in the liquid detergent composition of the present invention is dialkyl sulfosuccinates. The dialkyl sulfosuccinates may be a C₆₋₁₅ linear or branched dialkyl sulfosuccinate. The alkyl moieties may be symmetrical (i.e., the same alkyl moieties) or asymmetrical (i.e., different alkyl moieties). Preferably, the alkyl moiety is symmetrical. The use of the dialkyl sulfosuccinates, without being limited by a theory, improves the hydrophobicity and wetting capability leading to better cleaning results of greasy and/or starch soils. The ClogP of the dialkyl sulfosuccinates is greater than 2.0. The ClogP can be used to distinguish suitable sulfosuccinates, such as the dialkyl sulfosuccinates of the present invention. Preferred ranges for the ClogP are from 2.0 to 6.0, more preferred from 3.0 to 5.5. By comparison, the ClogP of monoalkyl sulfosuccinates is about 1.0.

The ClogP value relates to the octanol/water partition coefficient of a material. Specifically, the octanol/water partition coefficient (P) is a measure of the ratio of the concentration of a particular polymer in octanol and in water at equilibrium. The partition coefficients are reported in logarithm of base 10 (i.e., logP). The logP values of many materials have been reported and may be calculated via various methods including the Pomona92 database, available from Daylight Chemical Information Systems, Inc. and the United States Environmental Protection Agency also has available an Estimation Programs Interface for Windows (EPI-Win) that can be used to calculate the CLogP (or Log Kow). The preferred calculation tool is the EPI-Win model to calculate CLogP or LogKow based on polymer structures.

In one embodiment, the dialkyl sulfosuccinate is preferably branched, more preferably having a C₁-C₃ alkyl branch in the middle of the alkyl moiety (not on the α or β carbon of the alkyl moiety), most preferably from a secondary alcohol source, including, but not limited to, dibutyl hexanol and dioctyl hexanol. This placement of the branch on the alkyl moiety (not on the α or β carbon of the alkyl moiety) may be referred to as a “mid-chain” branch.

Preferred dialkyl moieties are selected from C₆₋₁₃ linear or branched dialkyl sulfosuccinates. Nonlimiting examples include linear dihexyl sulfosuccinate, branched dioctyl sulfosuccinate and linear bis(tridecyl) sulfosuccinate.

The dialkyl sulfosuccinates may be present in the liquid detergent composition from about 0.5% to about 10% by weight of the composition. In one embodiment, the dialkyl sulfosuccinates are preferably present in the liquid detergent composition from about 2% to about 5% by weight of the composition. In another embodiment, the dialkyl sulfosuccinates are preferably present in the liquid detergent composition from about 1% to about 10% by weight of the composition.

Nonionic Surfactants

Optionally the nonionic surfactant, when present in the composition, is present in an effective amount, more preferably from 0.1% to 20%, even more preferably 0.1% to 15%, even more preferably still from 0.5% to 10%,by weight of the liquid detergent composition.

Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. Also suitable are alkylpolyglycosides having the formula R²O(CₙH₂ₙO)ₜ(glycosyl)ₓ (formula (III)), wherein R² of formula (III) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (III) is 2 or 3, preferably 2; t of formula (III) is from 0 to 10, preferably 0; and x of formula (III) is from 1.3 to 10, preferably from 1.3 to 3, most preferably from 1.3 to 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Also suitable are fatty acid amide surfactants having the formula (IV): 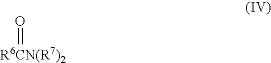
wherein R⁶ of formula (IV) is an alkyl group containing from 7 to 21, preferably from 9 to 17, carbon atoms and each R⁷ of formula (IV) is selected from the group consisting of hydrogen, C₁-C₄ alkyl, C₁-C₄ hydroxyalkyl, and —(C₂H₄O)ₓH where x of formula (IV) varies from 1 to 3. Preferred amides are C₈-C₂₀ ammonia amides, monoethanolamides, diethanolamides, and isopropanolamides.
Other Linear Amine Oxide surfactants

An optionally component used in the liquid detergent composition of the present invention is linear amine oxides. Amine oxides, for optional use herein, include water-soluble linear amine oxides containing one linear C₈₋₁₈ alkyl moiety and 2 moieties selected from the group consisting of C₁₋₃ alkyl groups and C₁₋₃ hydroxyalkyl groups; water-soluble phosphine oxides containing one linear C₁₀₋₁₈ alkyl moiety and 2 moieties selected from the group consisting of C₁₋₃ alkyl groups and C₁₋₃ hydroxyalkyl groups; and water-soluble sulfoxides containing one linear C₁₀₋₁₈ alkyl moiety and a moiety selected from the group consisting of C₁₋₃ alkyl and C₁₋₃ hydroxyalkyl moieties.

Preferred amine oxide surfactants have formula (V): 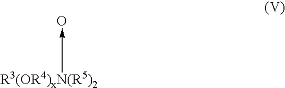
wherein R³ of formula (V) is a linear C₈₋₂₂ alkyl, linear C₈₋₂₂ hydroxyalkyl, C₈₋₂₂ alkyl phenyl group, and mixtures thereof; R⁴ of formula (V) is an C₂₋₃ alkylene or C₂₋₃ hydroxyalkylene group or mixtures thereof; x is from 0 to about 3; and each R⁵ of formula (V) is an C₁₋₃ alkyl or C₁₋₃ hydroxyalkyl group or a polyethylene oxide group containing an average of from about 1 to about 3 ethylene oxide groups. The R⁵ groups of formula (V) may be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides. Preferred amine oxides include C₁₀, C₁₀-C₁₂, and C₁₂-C₁₄ alkyl dimethyl amine oxides.

When present, at least one amine oxide will be present in the liquid detergent composition from about 0.1% to about 15%, more preferably at least about 0.2% to about 12% by weight of the composition. In one embodiment, the amine oxide is present in the liquid detergent composition from about 5% to about 12% by weight of the composition. In another embodiment, the amine oxide is present in the liquid detergent composition from about 3% to about 8% by weight of the composition.

Ampholytic Surfactants

Other suitable, non-limiting examples of amphoteric detergent surfactants that are optional in the present invention include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group.

Typically, when present, ampholytic surfactants comprise from about 0.01% to about 20%, preferably from about 0.5% to about 10% by weight of the liquid detergent composition.

Magnesium Ions

The optional presence of magnesium ions may be utilized in the detergent composition when the compositions are used in softened water that contains few divalent ions. When utilized, the magnesium ions preferably are added as a hydroxide, chloride, acetate, sulfate, formate, oxide or nitrate salt to the compositions of the present invention.

When included, the magnesium ions are present at an active level of from 0.01% to 1.5%, preferably from 0.015% to 1%, more preferably from 0.025% to 0.5%, by weight of the liquid detergent composition.

Solvent

While not preferred, the present liquid detergent compositions may optionally comprise a solvent. Suitable solvents include C₄₋₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof.

Preferred solvents are selected from methoxy octadecanol, ethoxyethoxyethanol, benzyl alcohol, 2-ethylbutanol and/or 2-methylbutanol, 1-methylpropoxyethanol and/or 2-methylbutoxyethanol, linear C₁-C₅ alcohols such as methanol, ethanol, propanol, isopropanol, butyl diglycol ether (BDGE), butyltriglycol ether, tert-amyl alcohol, glycerol and mixtures thereof. Particularly preferred solvents which can be used herein ate butoxy propoxy propanol, butyl diglycol ether, benzyl alcohol, butoxypropanol, propylene glycol, glycerol, ethanol, methanol, isopropanol and mixtures thereof.

Other suitable solvents for use herein include propylene glycol derivatives such as n-butoxypropanol or n-butoxypropoxypropanol, water-soluble CARBITOL R® solvents or water-soluble CELLOSOLVE R® solvents. Water-soluble CARBITOL R® solvents are compounds of the 2-(2-alkoxyethoxy)ethanol class wherein the alkoxy group is derived from ethyl, propyl or butyl; a preferred water-soluble CARBITOL® is 2-(2-butoxyethoxy)ethanol, also known as BUTYL CARBITOL®. Water-soluble CELLOSOLVE R® solvents are compounds of the 2-alkoxyethoxy ethanol class, with 2-butoxyethoxyethanol being preferred. Other suitable solvents include benzyl alcohol, and diols such as 2-ethyl-1,3-hexanediol and 2,2,4-trimethyl-1,3-pentanediol and mixtures thereof. Some preferred solvents for use herein are n-butoxypropoxypropanol, 2-(2-butoxyethoxy)ethanol and mixtures thereof.

The solvents can also be selected from the group of compounds comprising ether derivatives of mono-, di- and tri-ethylene glycol, butylene glycol ethers, and mixtures thereof. The weight average molecular weights of these solvents are preferably less than 350, more preferably between 100 and 300, even more preferably between 115 and 250. Examples of preferred solvents include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename DOWANOL® and from the Arco Chemical Company under the tradename ARCOSOLV®. Other preferred solvents including mono- and di-ethylene glycol n-hexyl ether are available from the Union Carbide Corporation.

When present, the liquid detergent composition will contain 0.01%-20%, preferably 0.5%-20%, more preferably 1%-10% by weight of the liquid detergent composition of a solvent. These solvents may be used in conjunction with an aqueous liquid carrier, such as water, or they may be used without any aqueous liquid carrier being present.

Hydrotrope

The liquid detergent compositions of the invention may optionally comprise a hydrotrope in an effective amount so that the liquid detergent compositions are appropriately compatible in water. By “appropriately soluble in water”, it is meant that the product dissolves quickly enough in water as dictated by both the washing habit and conditions of use. Products that do not dissolve quickly in water can lead to negatives in performance regarding overall grease and/or cleaning, sudsing, ease of rinsing of product from surfaces such as dishes/glasses etc. or product remaining on surfaces after washing. Inclusion of hydrotropes also serves to improve product stability and formulatibility as is well known in the literature and prior art.

Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, and related compounds, as disclosed in U.S. Pat. No. 3,915,903.

The liquid detergent compositions of the present invention typically comprise from 0% to 15% by weight of the liquid detergent composition of a hydrotropic, or mixtures thereof, preferably from 1% to 10%, most preferably from 3% to 6% by weight.

Hydrophobic Block Polymer

The liquid detergent compositions of the invention may optionally comprise a hydrophobic block polymer having alkylene oxide moieties and a weight average molecular weight of at least 500, but preferably less than 10,000, more preferably from 1000 to 5000 and most preferably from 1500 to 3500. Suitable hydrophobic polymers have a water solubility of less than about 1%, preferably less than about 0.5%, more preferably less than about 0.1% by weight of the polymer at 25° C.

“Block polymers” as used herein is meant to encompass polymers including two or more different homopolymeric and/or monomeric units which are linked to form a single polymer structure. Preferred copolymers comprise ethylene oxide as one of the monomeric units. More preferred copolymers are those with ethylene oxide and propylene oxide. The ethylene oxide content of such preferred polymers is more than about 5 wt %, and more preferably more than about 8 wt %, but less than about 50 wt %, and more preferably less than about 40 wt %. A preferred polymer is ethylene oxide/propylene oxide copolymer available from BASF under the tradename PLURONIC L81® or PLURONIC L43®.

The liquid detergent compositions of the present invention optionally comprise from 0% to 15% by weight of the liquid detergent composition of one or more hydrophobic block polymer(s), preferably from 1% to 10%, most preferably from 3% to 6% by weight.

Thickening Agent

If the desired viscosity of is too thin, the liquid detergent compositions herein can also contain from about 0.2% to 5% by weight of the liquid detergent composition of a thickening agent. More preferably, such a thickening agent will comprise from about 0.5% to 2.5% of the liquid detergent compositions herein. Thickening agents are typically selected from the class of cellulose derivatives. Suitable thickeners include hydroxy ethyl cellulose, hydroxyethyl methyl cellulose, carboxy methyl cellulose, cationic hydrophobically modified hydroxyethyl cellulose, available from Amerchol Corporation as QUATRISOFT® LM200, and the like. A preferred thickening agent is hydroxypropyl methylcellulose.

Polymeric Suds Stabilizer

The liquid detergent compositions of the present invention may optionally contain a polymeric suds stabilizer. These polymeric suds stabilizers provide extended suds volume and suds duration of the liquid detergent compositions. These polymeric suds stabilizers may be selected from homopolymers of (N,N-dialkylamino) alkyl esters and (N,N-dialkylamino) alkyl acrylate esters. The weight average molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.
One preferred polymeric suds stabilizer is (N,N-dimethylamino)alkyl acrylate esters, namely the acrylate ester represented by the formula (VI):

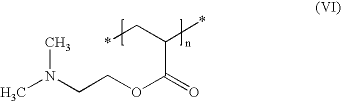

When present in the compositions, the polymeric suds booster may be present in the composition from 0.01% to 15%, preferably from 0.05% to 10%, more preferably from 0.1% to 5%, by weight.

Diamines

Another optional ingredient of the compositions according to the present invention is a diamine. Since the habits and practices of the users of liquid detergent compositions show considerable variation, the composition will preferably contain 0% to about 15%, preferably about 0.1% to about 15%, preferably about 0.2% to about 10%, more preferably about 0.25% to about 6%, more preferably about 0.5% to about 1.5% by weight of said composition of at least one diamine.

Preferred organic diamines are those in which pK1 and pK2 are in the range of 8.0 to 11.5, preferably in the range of 8.4 to 11, even more preferably from 8.6 to 10.75. Preferred materials include 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (DYTEK EP®) (pK1=10.5; pK2=8.9), 2-methyl 1,5 pentane diamine (DYTEK A®) (pK1=11.2; pK2=10.0). Other preferred materials include primary/primary diamines with alkylene spacers ranging from C₄ to C₈. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by DUPONT®, a supplier of diamines. As a working definition herein, the pKa of the diamines is specified in an all-aqueous solution at 25° C. and for an ionic strength between 0.1 to 0.5 M.

Carboxylic Acid

The liquid detergent compositions according to the present invention may comprise a linear or cyclic carboxylic acid or salt thereof to improve the rinse feel of the composition. The presence of anionic surfactants, especially when present in higher amounts (15-35% by weight of the composition) results in the composition imparting a slippery feel to the hands of the user and the dishware. This feeling of slipperiness is reduced when using the carboxylic acids as defined herein i.e. the rinse feel becomes draggy.

Carboxylic acids useful herein include C₁₋₆ linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2,4 benzene tricarboxylic acid, pentanoic acid and salts thereof and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof, when present, is preferably present at the level of from 0.1% to 5%, more preferably from 0.2% to 1% and most preferably from 0.25% to 0.5%.

Builder

The compositions according to the present invention may further comprise a builder system. If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula (VII)

R—CH(COOH)CH₂(COOH) wherein R of formula (VII) is C₁₀₋₂₀ alkyl or alkenyl, preferably C₁₂₋₁₆, or wherein R of formula (VII) can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they may be included in amounts of from 0.5% to 50% by weight of the composition, preferably from 0.5% to 25%, and more preferably from 0.5% to 5% by weight of the liquid detergent composition.

Enzymes

Detergent compositions of the present invention optionally may further comprise one or more enzymes which provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof.

A preferred combination is a detergent composition having a cocktail of conventional applicable enzymes like protease, amylase, lipase, cutinase and/or cellulase. Enzymes when present in the compositions, at from 0.0001% to 5% of active enzyme by weight of the detergent composition. Preferred proteolytic enzymes, then, are selected from the group consisting of SAVINASE®; MAXATASE®; MAXACAL®; MAXAPEM 15®; subtilisin BPN and BPN′; Protease B; Protease A; Protease D(Genencor); PRIMASE(®; DURAZYM®; OPTICLEAN®; and OPTIMASE®; and ALCALASE® (Novo Industri A/S), and mixtures thereof. Protease B is most preferred. Preferred amylase enzymes include TERMAMYL®, DURAMYL® and the amylase enzymes those described in WO 9418314 to Genencor International and WO 9402597 to Novo.

Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined.

Amino carboxylates useful as optional chelating agents include ethylene diamine tetracetates, N-hydroxy ethyl ethylene diamine triacetates, nitrilo-tri-acetates, ethylenediamine tetraproprionates, triethylene tetraamine hexacetates, diethylene triamine pentaacetates, and ethanol diglycines, alkali metal, ammonium, and substituted ammonium salts therein and mixtures therein.

Amino phosphonates are also suitable for use as chelating agents in the compositions of the invention when at least low levels of total phosphorus are permitted in detergent compositions, and include ethylene diamine tetrakis (methylene phosphonates) available under the tradename DEQUEST®. Amino phosphonates that do not contain alkyl or alkenyl groups with more than 6 carbon atoms are preferred. Polyfunctionally-substituted aromatic chelating agents are also useful in the liquid detergent compositions herein, preferably in acid form. See U.S. Pat. No. 3,812,044, issued May 21, 1974, to Connor et al. Preferred compounds include dihydroxydisulfobenzenes such as 1,2-dihydroxy-3,5-disulfobenzene. A preferred biodegradable chelator for use herein is ethylenediamine disuccinate (“EDDS”), especially the [S,S] isomer as described in U.S. Pat. No. 4,704,233, Nov. 3, 1987, to Hartman and Perkins. The liquid detergent compositions herein may also contain water-soluble methyl glycine diacetic acid (MGDA) salts (or acid form) as a chelant or co-builder. Similarly, the so called “weak” builders such as citrate can also be used as chelating agents.

If utilized, chelating agents may comprise from 0.00015% to 15% by weight of the liquid detergent compositions herein. More preferably, if utilized, the chelating agents will comprise from 0.0003% to 3.0% by weight of such compositions.

Preferably, the liquid detergent compositions herein are formulated as clear liquid compositions. By “clear” it is meant stable and transparent. Preferred liquid detergent compositions in accordance with the invention are clear single phase liquids, but the invention also embraces clear and opaque products containing dispersed phases, such as beads or pearls as described in U.S. Pat. No. 5,866,529, to Erilli, et al., and U.S. Pat. No. 6,380,150, to Toussaint, et al., provided that such products are physically stable (i.e., do not separate) on storage.

The liquid detergent compositions of the present invention may be packages in any suitable packaging for delivering the liquid detergent composition for use. Preferably the package is a clear package made of glass or plastic.

Other Optional Components:

The liquid detergent compositions herein can further comprise a number of other optional ingredients suitable for use in liquid detergent compositions such as perfume, dyes, opacifiers, and pH buffering means so that the liquid detergent compositions herein generally have a pH of from 4 to 14, preferably 6 to 13, most preferably 6 to 10. A further discussion of acceptable optional ingredients suitable for use in liquid detergent compositions, specifically light-duty liquid detergent composition may be found in U.S. Pat. No. 5,798,505.

Method of Use

In the method aspect of this invention, soiled dishes are contacted with an effective amount, typically from about 0.5 ml. to about 20 ml. (per 25 dishes being treated), preferably from about 3 ml. to about 10 ml., of the liquid detergent composition of the present invention diluted in water. The actual amount of liquid detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. The particular product formulation, in turn, will depend upon a number of factors, such as the intended market (i.e., U.S., Europe, Japan, etc.) for the composition product. Suitable examples may be seen below in Table I.

Generally, from about 0.01 ml. to about 150 ml., preferably from about 3 ml. to about 40 ml. of a liquid detergent composition of the invention is combined with from about 2000 ml. to about 20000 ml., more typically from about 5000 ml. to about 15000 ml. of water in a sink having a volumetric capacity in the range of from about 1000 ml. to about 20000 ml., more typically from about 5000 ml. to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of use will comprise immersing the soiled dishes into a water bath without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Test Methods

Viscosity Test Method

The viscosity of the composition of the present invention is measured on a Brookfield viscometer model # LVDVII+ at 20° C. The spindle used for these measurements is S31 with the appropriate speed to measure products of different viscosities; e.g., 12 rpm to measure products of viscosity greater than 1000 cps; 30 rpm to measure products with viscosities between 500 cps-1000 cps; 60 rpm to measure products with viscosities less than 500 cps.

Test for Viscosity Upon Dilution

The initial viscosity of the liquid detergent composition (100 wt %) is measured as described above in the Viscosity Test Method. For dilution samples at 80 wt % and 10 wt %, prepare a 100 gram sample of water (7 grains/gallon) and liquid detergent composition of an 80 wt % and 10 wt % by weight of the sample of the liquid detergent composition according to the present invention. Take viscosity measurements for each product dilution at 21° C. Viscosity upon dilution gives an idea whether the product will dissolve faster in water or if it will remain undissolved in water. A large increase in viscosity at 80 wt % (more than 100 cps from 100 wt % viscosity) indicates the liquid detergent composition's surfactant system is water insoluble. Acceptable dilution viscosities are shown below in Table I.

TABLE I
Target Dilution Viscosities

| Dilution level | |
|---|---|
| (wt % of liquid | |
| detergent | |
| composition in | |
| water | Viscosity (cps) |
| 100 wt % | Less than or equal to 700 cps for high viscosity formulas |
| | Less than or equal to 200 cps for low viscosity formulas |
| 80 wt % | Less than or equal to 750 cps for high viscosity formulas |
| | Less than or equal to 200 cps for low viscosity formulas |
| 10 wt % | Less than or equal to 100 cps for high viscosity formulas |
| | Less than or equal to 50 cps for low viscosity formulas |

TABLE II
High Viscosity Formulations

Composition

| | A* | B |
|---|---|---|
| C₁₂₋₁₃ AE0.6S¹ | — | — |
| C₁₂₋₁₃ Natural AE0.6S | 29.0 | 29.0 |
| C₁₀₋₁₄ mid-branched Amine | — | 6.0 |
| Oxide | | |
| C₁₂₋₁₄ Linear Amine Oxide | 6.0 | — |
| SAFOL ® 23 Amine Oxide | 1.0 | 1.0 |
| C₁₁E₉ Nonionic² | 2.0 | 2.0 |
| Ethanol | 4.5 | 4.5 |
| Sodium cumene sulfonate | 1.6 | 1.6 |
| Polypropylene glycol 2000 | 0.8 | 0.8 |
| NaCl | 0.8 | 0.8 |
| 1,3 BAC Diamine³ | 0.5 | 0.5 |
| Suds boosting polymer⁴ | 0.2 | 0.2 |
| Water | Balance | Balance |
| Viscosity (100%) cps | 720 | 680 |
| Viscosity (80%) cps | 915 | 700 |
| Viscosity (10%) cps | 140 | 80 |
| \|100% visc − 80% visc\|cps | 195 | 20 |
| \|100% visc. − 10% visc.\| | 580 | 600 |
| cps | | |

*Composition A is representative of an undesired viscosity.
¹C₁₂₋₁₃ alkyl ethoxy sulfonate containing an average of 0.6 ethoxy groups.
²Nonionic may be either C₁₁ Alkyl ethoxylated surfactant containing 9 ethoxy groups.
³1,3, BAC is 1,3 bis(methylamine)-cyclohexane.
⁴(N,N-dimethylamino)ethyl methacrylate homopolymer

TABLE III
Low viscosity formulations

Composition

| | C* | D |
|---|---|---|
| C₁₂₋₁₃ AE0.6S¹ | — | — |
| C₁₂₋₁₃ Natural AE0.6S | 22.5 | 22.5 |
| C₁₀₋₁₄ mid-branched Amine | — | 7.5 |
| Oxide | | |
| C₁₂₋₁₄ Linear Amine Oxide | 7.5 | — |
| C₁₀E₈ Nonionic² | 6.5 | 6.5 |
| Ethanol | 6.5 | 6.5 |
| NaCl | 1.0 | 1.0 |
| Sodium cumene sulfonate | 3.0 | 3.0 |
| 1,3 BAC Diamine³ | 0.5 | 0.5 |
| Suds boosting polymer⁴ | 0.2 | 0.2 |
| Water | Balance | Balance |
| Viscosity (100%) cps | 300 | 110 |
| Viscosity (80%) cps | 430 | 95 |
| Viscosity (10%) cps | 70 | 30 |
| \|100% visc − 80% visc\|cps | 130 | 15 |
| \|100% visc. − 10% visc.\| | 230 | 80 |
| cps | | |

*Composition C is representative of an undesired viscosity profile.
¹C₁₂₋₁₃ alkyl ethoxy sulfonate containing an average of 0.6 ethoxy groups.
²Nonionic may be either C₁₀ Alkyl ethoxylated surfactant containing 8 ethoxy groups.
³1,3, BAC is 1,3 bis(methylamine)-cyclohexane.
⁴(N,N-dimethylamino)ethyl methacrylate homopolymer

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
(a) naturally derived C₁₀₋₂₀ alkyl or hydroxyalkyl sulphate or sulphonate surfactant;
(b) mid-chain branched amine oxide comprising one alkyl moiety having n₁ carbon atoms and an alkyl branch having n₂ carbon atoms, wherein the alkyl branch is located on the α or β carbon from the nitrogen; and
(c) a liquid carrier.

2. The liquid detergent composition according to claim 1 wherein the liquid cleaning composition has a desired viscosity profile.

3. The liquid detergent composition according to claim 1 wherein the number of carbon atoms of the one alkyl moiety and the number of carbon atoms of the alkyl branch are such that |n₁−n₂| is less than or equal to 5 carbon atoms in at least 35 wt % of the mid-branched amine oxides.

4. The liquid detergent composition according to claim 3 wherein the number of carbon atoms of the one alkyl moiety and the number of carbon atoms of the alkyl branch are such that |n₁−n₂| is less than or equal to 5 carbon atoms in 75 wt % to 100 wt % of the mid-branched amine oxides.

5. The liquid detergent composition according to claim 3 wherein the number of carbon atoms of the one alkyl moiety and the number of carbon atoms of the alkyl branch are such that |n₁−n₂| is from 0 to 4 carbon atoms.

6. The liquid detergent composition according to claim 1 wherein the total sum of n₁ and n₂ is from 12 to 20.

7. The liquid detergent composition according to claim 1 wherein the total sum of n₁ and n₂ is from 10 to 16.

8. The liquid detergent composition according to claim 1 wherein the mid-branched amine oxide has formula (I): 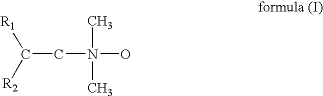
wherein R₁ and R₂ of formula (I), plus the α and β carbons from the nitrogen, have 10-24 carbon atoms.

9. The liquid detergent composition according to claim 1 wherein the sulfate or sulphonate surfactant is selected from linear alkyl sulphonate, alkyl alkoxylated sulfate, and mixtures thereof.

10. The liquid detergent composition according to claim 1 further comprising from about 30% to about 80% by weight of the liquid detergent composition of an aqueous liquid carrier.

11. The liquid detergent composition according to claim 1 wherein the composition further comprises from about 2% to about 5% by weight of the composition a C₆-C₁₄ linear or branched dialkyl sulfosuccinate.

12. The liquid detergent composition according to claim 1 further comprising from about 0.1% to about 20% by weight of the liquid detergent composition of a nonionic surfactant.

13. The liquid detergent composition according to claim 9 wherein the nonionic surfactant selected from the group of C₈-C₂₂ aliphatic alcohols with 1 to 25 moles of ethylene oxide, alkylpolyglycosides, fatty acid amide surfactants, and mixtures thereof.

14. The liquid detergent composition according to claim 11 further comprising from about 0.01% to about 20% by weight of the liquid detergent composition of a solvent and from 0% to about 15% by weight of the liquid detergent composition of a hydrotrope.

15. The liquid detergent composition according to claim 11 further comprising from about 0.01% to about 15% by weight of the liquid detergent composition of a hydrophobic block polymer.

16. The liquid detergent composition according to claim 11 further comprising from about 0.1% to about 4% by weight of the liquid detergent composition of magnesium ions, from 0% to about 15% by weight of the liquid detergent composition of a diamine, or mixtures thereof.

17. The liquid detergent composition according to claim 1 wherein the liquid detergent composition is a high viscosity formulation.

18. The liquid detergent composition according to claim 1 wherein the liquid detergent composition is a low viscosity formulation.

19. The liquid detergent composition according to claim 1 wherein the liquid detergent composition is a clear liquid.

20. A method of washing dishes with the liquid detergent composition according to claim 1, wherein 0.01 ml to 150 ml of said liquid detergent composition is diluted in 2000 ml to 20000 ml water, and the dishes are immersed in the diluted composition thus obtained and cleaned by contacting the soiled surface of the dish with a cloth, a sponge or a similar article.

21. A method of washing dishes, wherein the dishes are immersed in a water bath and an effective amount of a liquid detergent composition according to claim 1 is absorbed onto a device, and the device with the absorbed liquid detergent composition is contacted individually to the surface of each of the soiled dishes.
